(19) United States
(12) Patent Application Publication
(10) Pub. No.: US 2009/0012775 A1
(43) Pub. Date: Jan. 8, 2009

(54) METHOD FOR TRANSLITERATING AND SUGGESTING ARABIC REPLACEMENT FOR A GIVEN USER INPUT

(75) Inventors: AMR MOHAMED EL HADY, Cairo (EG); AHMED MOOTAZ ABDO, Cairo (EG); HANY MAHMOUD KAWY, Cairo (EG); MOEMEN MOHAMED EL SUEDY, Madinet Nasr (EG); AHMED MOHAMED EL AZAB, Cairo (EG)

Correspondence Address: SCULLY SCOTT MURPHY & PRESSER, PC, 400 GARDEN CITY PLAZA, SUITE 300, GARDEN CITY, NY, 11530, US

(73) Assignee: SHERIKAT LINK LETATWEER ELBARMAGUEYAT S.A.E., Cairo (EG)

(21) Appl. No.: 12/123,557

(22) Filed: May 20, 2008

(30) Foreign Application Priority Data
May 21, 2007 (EG) 259/2007

(51) Int. Cl. G06F 17/28

(52) U.S. Cl. 704/2

(57) ABSTRACT

A method for suggesting transliteration for user inputs, comprising: receiving an original user input composed of alpha-numeric characters; identifying the possibility of transliterating the input; determining at least one potential transliteration by performing at least one of the following (1) replacing a sequence of characters in the original input to a possible sequence of Arabic characters (2) determining the probabilities of the potential transliterated alternatives to the user input; and electing the most likely transliteration according to some predetermined criteria (3) verifying the suggested output against a validation repository, the validation repository having a large corpus of Arabic words.

### 1. BACKGROUND OF THE INVENTION

1.1. Field of Invention

The present invention relates to a method of transliteration of alpha-numeric Roman based words into its equivalent Arabic words. More specifically, it relates to systems and methods to generate transliterated alternative based on an original user input are disclosed.

1.2. Background Art

It became common in the recent era that people write Arabic words using Roman alpha-numeric alphabet. This has been widely used and understandable in the different Arab communications like emails, chatting, blogging, and recently for search engines along with others.

The Arabic alphabet is “impure” i.e. the short vowels are not written, though long ones are. Knowing the Arabic language is a must for a reader to be able to restore the vowels. Thus, users, for the sake of easiness and fast typing, have adopted a sequence of character mapping like “h” or “7” to be the character [symbol] in Arabic. Similarly, “t”, “m”, “3”, and “6” are mapped to [symbol] and [symbol] respectively. The Roman-input sequence allows for more than a character like “dh”, “3.”, and “6.” are highly probably to transliterate into [symbol] and [symbol] respectively.

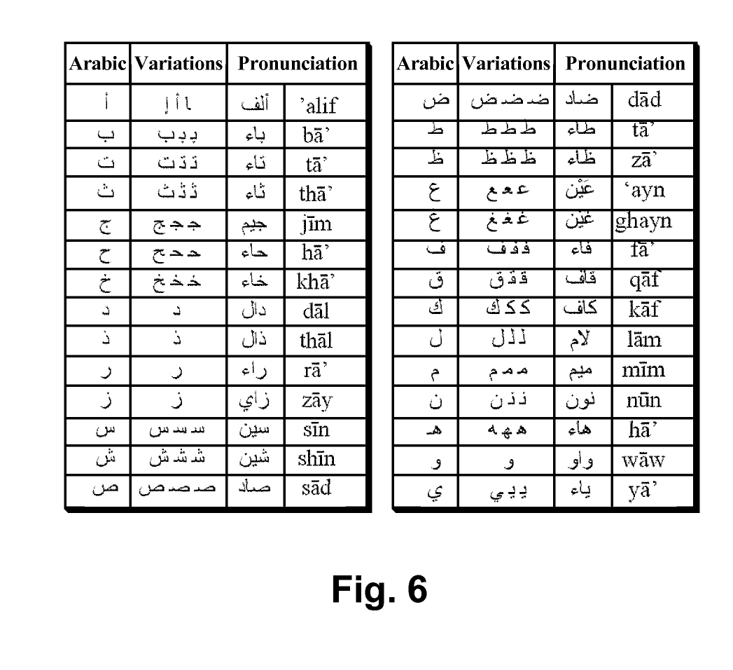

The number of letters in the Arabic alphabet (FIG. 6) is more than the standard of the Roman alphabet (e.g. English and French languages), thus some of the Arabic letters have no possible direct replacement in Latin [symbol] Replacements had to be introduced in a way that is usable and easy remembered to users.

Numerals were used to help as replacements of the missing letters. Those replacements were commonly chosen taking into consideration, sometimes, the similarity in shape, as much as possible, to the mapped Arabic language (e.g. 3 is mapped to [symbol] ).

People adopted such mapping, with no standardized rules, to use in e-mails, mobile Short Message Systems (a.k.a. SMS), chatting, and others.

The method according to the present invention transliterates the Roman-based user input, in the form of text words, into Arabic language. This system is not a merely direct one-to-one transliteration from one language, e.g. English into Arabic.

In many cases, depending on one-to-one mapping techniques was proven to produce usually erroneous miscellaneous and/or non-sense words. Consider the simple Roman-word “Ali”—it can be either [symbol] which are different words.

Another problem is the presence of different dialects used to pronounce the same Arabic word, making it even trickier to build transliteration rules, especially if the target is slang Arabic words.

The present invention is focusing on how to produce the best match based on different linguistic rules that takes into account the different various ways used, or probable to use, by different users to represent the same word.

The software according to the method does not analyze the meaning of the words or phrases being transliterated, but only displays the equivalent word in Arabic. It is incapable of creating new Arabic words from any data being input. Rather the generated words maybe further checked against a repository of Arabic words to validate.

In case of multiple possible transliterations available for the same input word, a probability element is involved giving preference to a certain transliteration over another. That might be controlled at a heuristic level based on a huge corpus of Arabic words usage and availability as an Arabic word in general. Not all the words are returned from a pure Arabic dictionary; rather an Arabic word can also include proper nouns or identity names and the like.

### 2. SUMMARY OF THE INVENTION

2.1. Brief Description of the Drawings

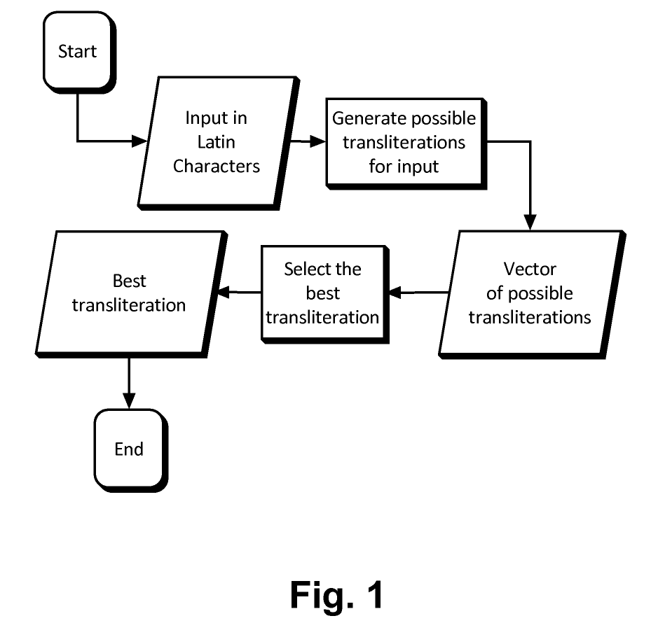

FIG. 1 is a diagram showing the process of transliterating a word staring with reading the user input through the invention till the transliteration is returned back.

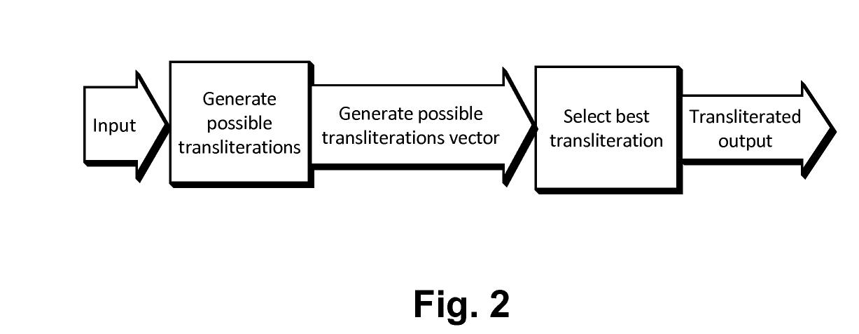

FIG. 2 is a block diagram showing the two main phases of transliteration of Arabic words written in Roman alpha-numerals. The first is generating a vector of r potential transliterated Arabic words based on the user input. The second block mapping to the second phase where the invention selects the most likely word transliteration.

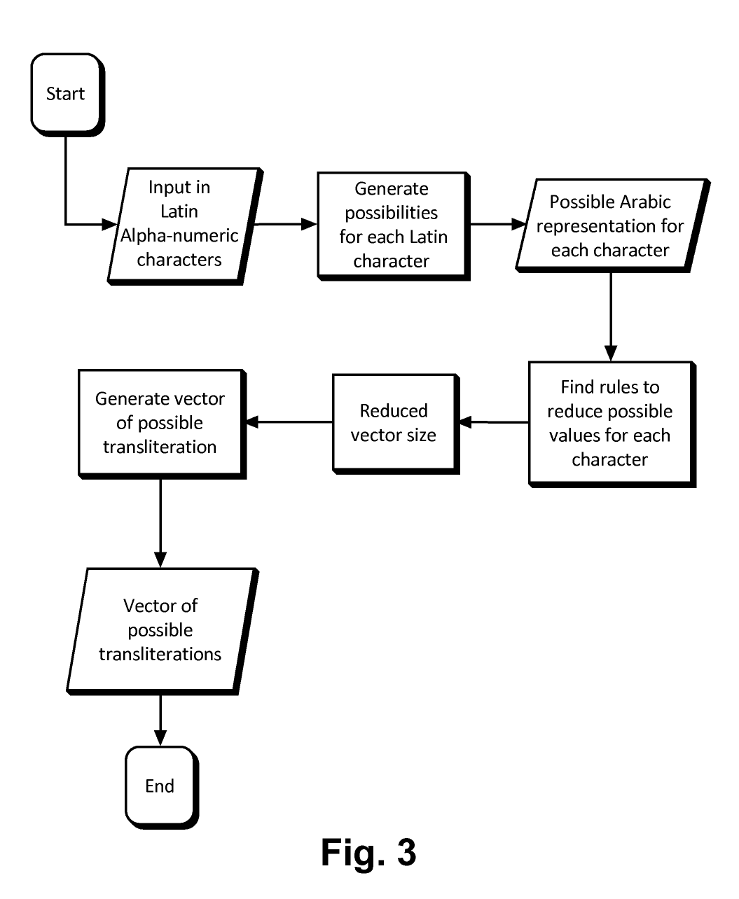

FIG. 3 shows the generation of a vector of potential transliterations. It explains the process of generation where the invention reads the input and tries to generate a vector containing all the possible transliterations for the original user input.

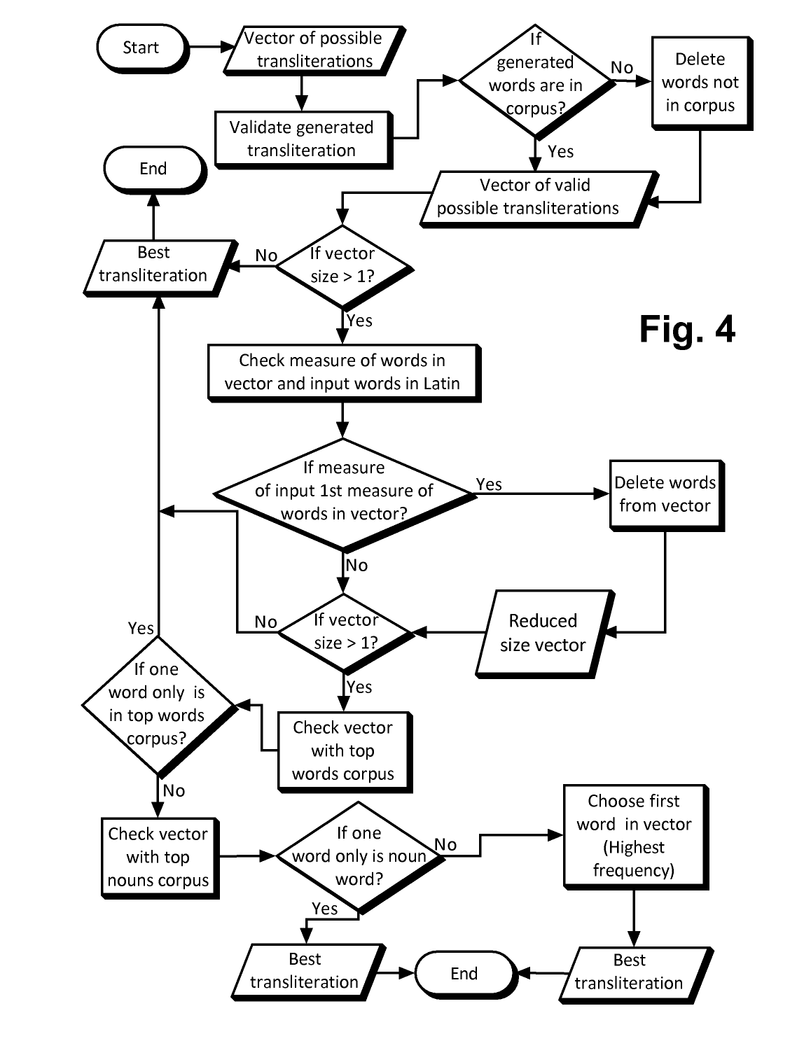

FIG. 4 shows the calculating the likelihood of a transliterated word. It explains the process of selecting the best possible transliteration for the input word from the vector that was generated in the generation phase and this is based on heuristics and shallow morphological analyzing.

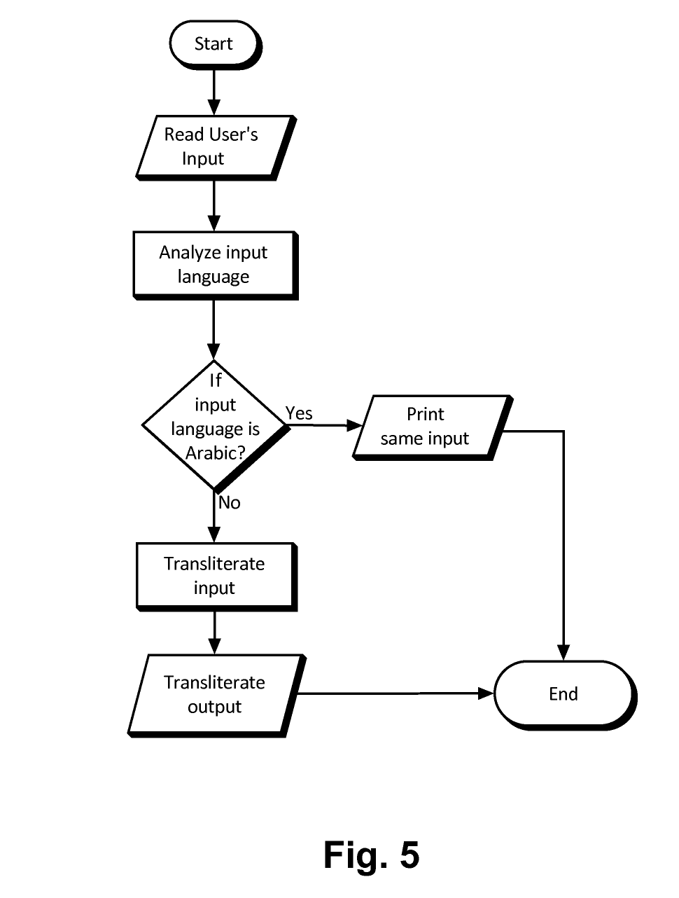

FIG. 5 shows a typical usage scenario, where the invention used as a service, receives the user input and returns the transliteration.

FIG. 6 is a table showing the Arabic alphabet

2.2. Detailed Description

Users typically have use non-standardized scheme to present an Arabic word in a transliterated form. The problem remained that one-to-one character mapping might not always produce the correct intended word for the user. For example the four-letter Arabic word [symbol] can be written in Roman as: ahmed, ahmad, a7mad, a7med, or a7md (table below).

| Arabic word | [symbol] |
|---|---|
| Possible Roman-based | ahmed |
| | ahmad |
| | a7mad |
| | a7med |
| | a7md |

As shown in FIGS. 1 and 5, the transliteration process starts with identifying the Roman-character input and generating a set of potential transliterations, then a second module will judge the priority of the words in the generated set, then a final decision is made in selecting the most likely word from the prioritized word list.

The first step of the transliteration process starts by the reading the user input in the form of alpha-numeral Roman characters. A set of possible Arabic transliterated words is initially composed based on a fixed tailored map of a Roman sequence of characters—one or more, giving a permutation of possible Arabic-equivalence.

Examples from the map:
“a” is mapped to Phi (φ) or [symbol]
“o” is mapped to Phi (φ) or [symbol]
“oo” is mapped to [symbol]
“b” mapped to [symbol]
“dh” is mapped to [symbol]
“3” is mapped to [symbol]
“6.” is mapped to

[symbol]

A complete table of character mapping from Roman to Arabic, referenced “map” hereunder, is established, and another table of generating rules is built on top of the character mapping. Both tables may be heuristically based from large history log files of Arabic words written with English characters.

The number of maximum possible words for a given single word input is calculated by the standard permutation equation:

$${P}_{r}^{n} = \frac{n !}{( n - r ) !}$$

where:
   r is the maximum possible number of character mapping,
   n is the number of characters in a given word, and
   ! is the factorial operator.

During the time of generation, heuristic linguistic rules are fired to reduce the size of the set of possible generated set. An example of a rule is: if ‘O’ is not the first character of the given inputs, the Arabic character [symbol] is removed from the set of possible replacements for the ‘O’ character. The sequence of generating the potential vector is shown in FIG. 3.

The words in the set will be prioritized according to the precedence of letters in the map (i.e. the null has higher precedence over other letters such as [symbol] if the Latin character belongs to the standard set of vowels).

The phase of selecting the best word proceeds forward from the generated set. This basically tests the vector of words to eliminate the non-Arabic words and thus minimizes the number of possibilities (FIGS. 2 and 4).

There is no standard way of writing an Arabic word with the Roman alphabet. For example the word [symbol] might be written as Imam or Emam and both will be commonly perceived right taking into account the phonetic similarity between “E” and “I”

The software according to the present invention is capable of dealing with such different representations of the same word (e.g. pakistan, pakestan, bakestan, and bakistan are four different formats that should be eventually perceived as [symbol] ).

| Intended word | [symbol] |
|---|---|
| Possible Representations | pakistan |
| | pakestan |
| | bakestan |
| | bakistan |

If the vector has exactly one possible transliteration, the process stops, and this word will be the potential output, as shown in FIG. 4.

If more than one possible transliteration is still in the vector, a new process will be invoked to check the many pre-evaluated measures of the words. Those measures are typically the most of the possible alignments that represent a huge portion of the Arabic words in general.

The priority value attached to each of the measures is unique and pre-determined according to certain criteria using shallow morphological analysis. Assuming the input word was “rafe3” and the vector still has the potential transliterations [symbol] The corresponding standard measures of the three of these are evaluated.

Based on the priority of the corresponding measure, exactly one word will be finally elected the best—due to the uniqueness of the priority value given to each of the measures. The one current best string will be the potential output for the user.

The last step for formally and optionally deciding whether to output the produced string or not is to check if it is actually an Arabic word.

The validation is done against a large corpus of Arabic words. Any words in the vector that are not in that corpus may be eliminated thus reducing the vector size avoiding transliterations that would not make sense. The corpus is not limited to one-time-generation and can be modified to allow word addition, edition or deletion.

With some predetermined criteria to judge the validity of the produced word according to the corpus, if the potential word remaining in the vector is decided to be valid, it will be determined as final and outputted to the user.

The methods of transliterating of alpha-numeric Roman-based words into its equivalent Arabic words consider that partial Roman string might not be the same one if used with a longer string.

Considering the difference between transliterating the string “elnad” and the string “elnady”: The first will eventually map to [symbol] while the latter, which includes the first as a substring, would be transliterated as

[symbol]

A complete string example would be “elnady elahly almo3aser” which most probably output [symbol] The figure below show how the partial steps may overwrite smaller partials.

| User Input | Output Text |
|---|---|
| el | [symbol] |

Step 1

| | |
|---|---|
| Eln | [symbol] |

Step 2

| | |
|---|---|
| Elnad | [symbol] |

Step 3

| | |
|---|---|
| Elnady | [symbol] |

Step 4

| | |
|---|---|
| elnady e | [symbol] |

Step 5

| | |
|---|---|
| elnady elah | [symbol] |

Step 6

| | |
|---|---|
| elnady elahly | [symbol] |

Step 7

| | |
|---|---|
| elnady elahly almo3aser | [symbol] |

Step 8

Details relating to technical material that is known in the technical fields related to the invention have not been described in detail so as not to unnecessarily obscure the present invention.

The invention thus conceived is susceptible of numerous modifications and variations, all of which are within the scope of the appended claims.

1- A method for suggesting transliteration for user inputs, comprising: receiving an original user input having alpha-numeric characters; identifying the possibility of transliterating the input; determining at least one potential transliteration by performing at least one of (1) replacing a sequence of characters in the original input to a possible sequence of Arabic characters (2) determining the probabilities of the potential transliterated alternatives to the user input; and electing the most likely transliteration according to some predetermined criteria (3) verifying the suggested output against a validation repository, the validation repository having a large corpus of Arabic words.

2- The method according to claim 1, wherein the original user input is in a Roman based language composed of both characters and numerals.

3- The method according to claim 1, a sequence of characters may contain one or more characters.

4- The method according to claim 1, further comprising: determining the possibility of having the original user input in a recent transliterated cache and hence outputting the most recent item from the cache if found.

5- The method according to claim 1, wherein the validation repository is generated from at least one of a user input log, a user input database, and numerous Arabic articles and websites.

6- The method according to claim 5, wherein the validation repository is generated by determining frequent word usages, and sorting this according to their frequencies.

7- The method according to claim 1, wherein computing the likelihoods t of the potential transliterated user inputs includes determining at least one of: (1) common association of user input and the potential transliterated version, (2) valid measures of the generated words with proper Arabic words and (3) a probability that the potential transliterated user input will be selected by the user.

8- The method according to claim 1, wherein a software is to be used with E a computer system, said software, comprises: a computer readable storage medium having data representing instructions executable by a computer on a computer processor, the instructions including: receiving an original user input; identifying the Roman-based terms in the original user input; producing at one or more transliterated user inputs by performing at least one of (1) replacing a sequence of characters in the original input to a possible sequence of Arabic characters (2) determining the probabilities of the potential transliterated alternatives to the user input; and electing the most likely transliteration according to some predetermined criteria (3) verifying the suggested output against a validation repository corpus, the validation repository having a large corpus of Arabic words.

9- A software according to claim 8, where the instructions further including: determining whether the exact user input was pre-evaluated in a cache of some recently transliterated inputs and upon that, outputting the cached transliteration for that input.

10- A software according to claim 8, wherein the original user input is in a Roman based language composed of both characters and numerals.

11- A software according to claim 8, wherein a sequence of characters may contain one or more characters.

12- A software according to claim 8, wherein the validation repository is generated from at least one of a user input log, a user input database, and numerous Arabic articles and websites.

13- Software according to claim 12, wherein the validation repository is generated by determining frequent word usages, and sorting this according to their frequencies.

14- Software according to claim 8, wherein computing the likelihoods of the potential transliterated user inputs includes determining at least one of. (1) common association of user input and the potential transliterated version, (2) valid measures of the generated words with proper Arabic words and (3) a probability that the potential transliterated user input will be selected by the user, and where the measures are a set of predetermined possible alignment that cover most of the Arabic words, and where the corpus is not limited to one-time-generation and can be modified to allow word addition, edition or deletion.
